(19) United States
(12) Patent Application Publication
(10) Pub. No.: US 2025/0349152 A1
(43) Pub. Date: Nov. 13, 2025

(54) INFORMATION SHARING SYSTEM, INFORMATION SHARING METHOD, AND SERVER DEVICE

(71) Applicant: Hiroki Ozaki, TOKYO (JP)

(72) Inventor: Hiroki Ozaki, TOKYO (JP)

(73) Assignee: Ricoh Company, Ltd., Tokyo (JP)

(21) Appl. No.: 19/177,985

(22) Filed: Apr. 14, 2025

(30) Foreign Application Priority Data
May 9, 2024 (JP) 2024-076544

(51) Int. Cl. G06V 40/20; G06F 3/14; G06V 40/16

(52) U.S. Cl. CPC G06V 40/20; G06F 3/14; G06V 40/172

(57) ABSTRACT

An information sharing system includes a device including device circuitry, at least one terminal device, and a server device including server circuitry. The device circuitry and the server circuitry operate in cooperation to: acquire image data from an imaging device that captures an image of a user of the at least one terminal device; analyze the acquired image data to recognize a gesture; store sharing count in association with the user of the at least one terminal device; perform face recognition on the image data to identify the user who performs the gesture; identify the user with lowest sharing count among users of the at least one terminal device who perform the gesture; receive the information from the at least one terminal device associated with the identified user; and display the received information on a display of the device.

### CROSS-REFERENCE TO RELATED APPLICATION

This patent application is based on and claims priority pursuant to 35 U.S.C. § 119(a) to Japanese Patent Application No. 2024-076544, filed on May 9, 2024, in the Japan Patent Office, the entire disclosure of which is hereby incorporated by reference herein.

### BACKGROUND

### Technical Field

The present disclosure relates to an information sharing system, an information sharing method, and a server device.

### Related Art

In educational institutions such as schools, systems for teaching with electronic teaching materials are utilized.

For example, a device operated by a teacher and terminal devices operated by users such as students communicate with each other so that the terminal devices can display teaching materials transmitted by the device or the device can display answers transmitted by the terminal devices.

Such a system has been developed to identify a user by face recognition.

### SUMMARY

The present disclosure described herein provides an information sharing system including a device, at least one terminal device, and a server device communicatively connected to the device and the at least one terminal device. The device includes device circuitry. The server device includes server circuitry. The device circuitry and the server circuitry operate in cooperation to: acquire image data from an imaging device that captures an image of a user of the at least one terminal device; analyze the acquired image data to recognize a gesture; store, in a memory, sharing count in association with the user of the at least one terminal device, the sharing count being number of times the device displays information displayed on the at least one terminal device; perform face recognition on the image data to identify the user who performs the gesture; identify the user with lowest sharing count among users of the at least one terminal device who perform the gesture; receive the information from the at least one terminal device associated with the identified user; and display the received information on a display of the device.

The present disclosure described herein provides an information sharing method including acquiring, analyzing, storing, performing, identifying, receiving, and displaying. The acquiring includes acquiring image data from an imaging device that captures an image of a user of at least one terminal device. The analyzing includes analyzing the image data to recognize a gesture. The storing includes storing sharing count in association with the user of the at least one terminal device. The sharing count is number of times a device displays information displayed on the at least one terminal device. The performing includes performing face recognition on the image data to identify the user who performs the gesture. The identifying includes identifying the user with lowest sharing count among users of the at least one terminal device who perform the gesture. The receiving includes receiving the information from the at least one terminal device associated with the identified user. The displaying includes displaying the information received from the at least one terminal device.

The present disclosure described herein provides a server device including circuitry that communicates with a device and at least one terminal device through a network. The device acquires image data from an imaging device and analyzes the image data to recognize a gesture. The imaging device captures an image of a user of the at least one terminal device. The circuitry stores, in a memory, sharing count in association with the user of the at least one terminal device. The sharing count is number of times the device displays information displayed on the at least one terminal device. The circuitry performs face recognition on the image data received from the device to identify the user who performs the gesture, identifies the user with lowest sharing count among users of the at least one terminal device who perform the gesture, receives the information from the at least one terminal device associated with the identify user, and transmits the information to the device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an information sharing system including student terminals, a teacher terminal, and a class management server;

FIG. 2 is a diagram illustrating a configuration of an information sharing system;

FIG. 3 is a diagram illustrating a hardware configuration of a class management server, a student terminal, or a teacher terminal;

FIG. 4 is a block diagram illustrating a functional configuration of a class management server, a student terminal, and a teacher terminal;

FIG. 5 is a diagram illustrating sharing count information stored in a sharing count storing unit;

FIG. 6 is a schematic diagram illustrating a process in which a class management server determines which student terminal is to share screen data with a teacher terminal and shares the screen data from the determined student terminal;

FIG. 7 is a sequence diagram illustrating a process in which a class management server determines which student terminal is to share screen data with a teacher terminal and causes the teacher terminal to share the screen data from the determined student terminal;

FIG. 8 is a block diagram illustrating a functional configuration of a class management server, a student terminal, and a teacher terminal;

FIG. 9 is a schematic diagram illustrating a process in which a class management server displays students in the order in which the students raise their hands;

FIG. 10 is a sequence diagram illustrating a process in which a class management server determines the order of students who raise their hands and a teacher terminal displays a list of students who raise their hands, ordered by the time the students raise their hands, along with sharing count;

FIG. 11 is a block diagram illustrating a functional configuration of a class management server, a student terminal, and a teacher terminal;

FIG. 12 is a schematic diagram illustrating a process in which a teacher terminal displays a list of students who raise their hands in ascending order of sharing count;

FIG. 13 is a sequence diagram illustrating a process in which a class management server sorts students by the sharing count of the students who raise their hands and a teacher terminal displays a list of students who raise their hands in ascending order of sharing count.

FIG. 14 is a block diagram illustrating a functional configuration of a class management server, a student terminal, and a teacher terminal;

FIG. 15 is a schematic diagram illustrating correct answer data information stored in a correct answer data storing unit;

FIG. 16 is a schematic diagram illustrating a process in which a class management server compares an answer input into a student terminal by each student who raises their hand with correct answer data and determines the student terminal for sharing screen data;

FIG. 17 is a sequence diagram illustrating a process in which a class management server determines a student terminal to be shared with a teacher terminal based on the similarity and shares the screen data from the determined student terminal.

FIG. 18 is a diagram illustrating a determination-method setting screen displayed on a teacher terminal;

FIG. 19 is a block diagram illustrating a functional configuration of a class management server, a student terminal, and a teacher terminal; and

FIG. 20 is a block diagram illustrating a functional configuration of a student terminal and a teacher terminal.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

An information sharing system and an information sharing method performed by the information sharing system are described below with reference to the drawings.

### First Embodiment

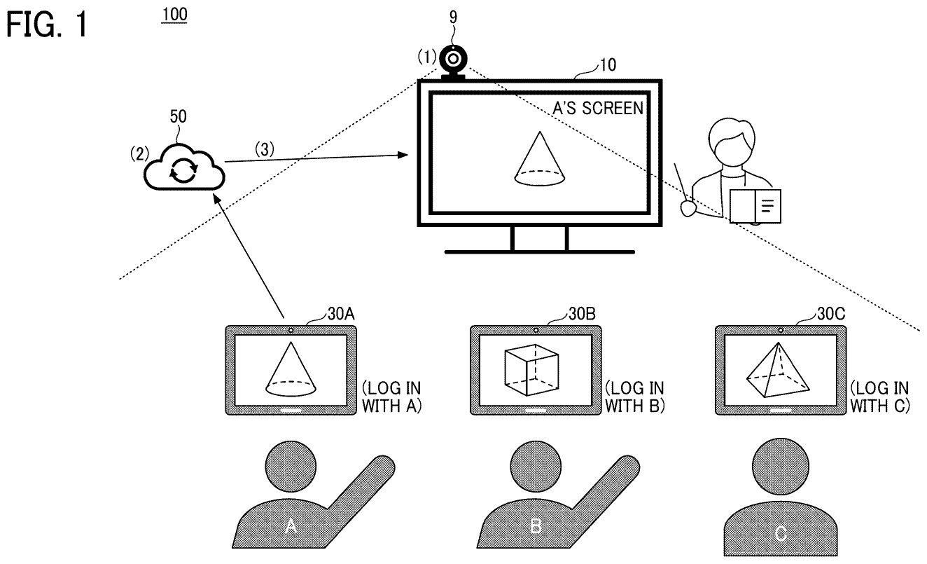

An overview of the operation of an information sharing system 100 is described below with reference to FIG. 1. FIG. 1 is a schematic diagram illustrating a configuration of the information sharing system 100 including student terminals 30, a teacher terminal 10, and a class management server 50. Any of multiple student terminals 30A to 30C, used by students A to C, may be referred to as a “student terminal 30” or “student terminals 30.”

The configuration of the information sharing system 100 is described below. A detailed description of the system configuration is deferred.

The class management server 50 stores student information such as authentication information or a face photograph.

The teacher terminal 10 and the student terminals 30A to 30C can communicate with the class management server 50 through a communication network N. The class management server 50 controls the teacher terminal 10 and the student terminals 30 that participate in a class. For example, when a student logs in to the class management server 50 with their student identification (ID) and password, the class ID is identified based on the timetable of the class to which the student belongs. Similarly, when the teacher logs in to the class management server 50 with their teacher ID and password, the class ID of the class that the teacher is in charge of is identified. The class management server 50 causes the students and the teacher having the same class ID to belong to the same virtual room.

The class management server 50 establishes a session between the teacher terminal 10 and the student terminals 30 belonging to the virtual room. The information sharing system 100 transmits screen data displayed on the teacher terminal 10 to the student terminals 30A to 30C so that the student terminals 30A to 30C can share the screen of the teacher terminal 10. The teacher terminal 10 can receive, from the student terminals 30A to 30C, for example, answers input by the students into the student terminals 30A to 30C. The teacher terminal 10 can display the answers from the student terminals 30 and determine whether the answers are correct or incorrect.

An overview of a procedure in which the teacher terminal 10 shares screen data displayed on the student terminals 30A to 30C is described below.
(1) The class management server 50 analyzes image data captured by an imaging device 9 and detects the gesture of a student raising their hand.
(2) The class management server 50 identifies the student (and the student terminal 30) by recognizing the face of the student who raises their hand.
(3) As one embodiment, the class management server 50 records sharing count, which is the number of shares, in the past for each of the student terminals 30, and identifies the student terminal 30 with the lowest sharing count among the students who raise their hands. The class management server 50 requests the student terminal 30 of the student who raises their hand to capture a screen on which the answer is displayed and acquires screen data from the student terminal 30. The class management server 50 transfers the screen data to the teacher terminal 10. The teacher terminal 10 then displays the screen data.

In this way, the teacher terminal 10 can display the answer of the student who raises their hand. Such a configuration prevents the bias in selecting the student terminal 30 to share the screen data, which may be caused by selecting the student who performs the gesture of raising their hand first.

### Terms

“Gesture” refers to one of body languages expressed by the motion of the body and refers to a body movement or a hand movement. The class management server 50 recognizes, for example, a student's gesture instructed by the teacher to smoothen the educational activity.

“Share” or “sharing” refers to the teacher terminal 10 displaying information displayed on the student terminal 30. The term “sharing count” or “number of shares” means the number of times information has been displayed, counted for each of the student terminals 30.

“Information displayed on the student terminal 30” is information to be shared by the teacher terminal 10 and the student terminals 30. The information is input by the student. For example, the information described below is an answer (screen data) by a student.

“Device” is a device operated by the teacher. “Terminal device” is a device operated by a student. “Teacher” used herein may be referred to as, for example, a lecturer, a professor, an instructor, or a trainer. “Student” may be referred to as, for example, a learner or a participant. “Class” may be referred to as, for example, a lecture, a meeting, a lesson, a seminar, a forum, a panel discussion, a roundtable discussion, or a lecture meeting.

### System Configuration

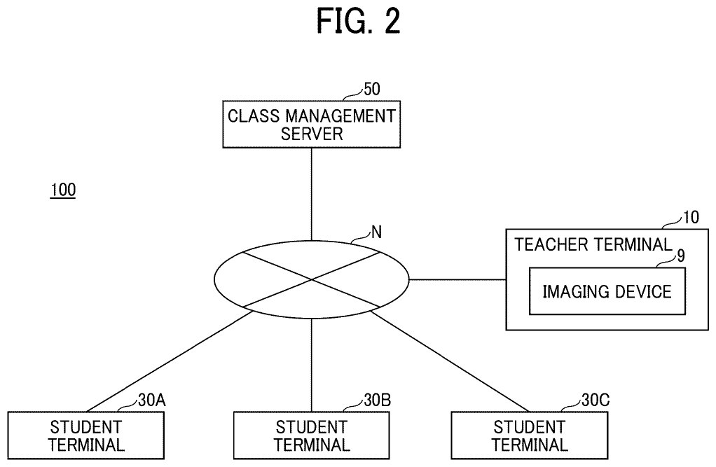

FIG. 2 is a diagram illustrating a configuration of the information sharing system 100. The information sharing system 100 includes the class management server 50, the teacher terminal 10, and one or more student terminals 30, which are connected to each other through the communication network N. Although FIG. 2 illustrates three student terminals 30A to 30C, the number of student terminals 30 may be the number of students in a single class, or a single student may have multiple student terminals 30.

The communication network N includes at least one of a local area network (LAN) installed in each classroom in a school, a provider network of a provider that connects the LAN to the Internet, and a line provided by a line carrier. For example, the teacher terminal 10 and the student terminals 30 are connected to a LAN while the class management server 50 is connected to the Internet or a cloud. The teacher terminal 10 and the student terminals 30 may be directly connected to a line telephone network or a mobile phone network without using a LAN. The communication network N may be wired, wireless, or a combination of both.

The teacher terminal 10 includes the imaging device 9. In FIG. 2, the imaging device 9 is built into the teacher terminal 10, thus being integrated with the teacher terminal 10. Alternatively, the imaging device 9 may be separated from the teacher terminal 10 and connected to the teacher terminal 10 by wire or wirelessly. The imaging device 9 is installed in, for example, the upper portion of the display of the teacher terminal 10, a platform, the ceiling or a wall of a classroom, or a desk. The imaging device 9 is a camera that captures images of students participating in the class. The imaging device 9 may be referred to as a digital still camera or a digital video camera. The imaging device 9 may be an omnidirectional camera that captures a 360-degree view of its surroundings in a single shot to generate an omnidirectional image. Regardless of the type of the imaging device 9, multiple imaging devices 9 may be arranged to reduce blind spots. The imaging device 9 may be a camera capable of acquiring distance information, such as a stereo camera or a Light Detection and Ranging (LiDAR) sensor.

The imaging device 9 may be a camera built into the student terminal 30. In this case, the student terminal 30 can capture the student without any obstacle. Thus, the blind spot can be reduced. The imaging device 9 may be connected to the communication network N instead of the teacher terminal 10 or may be connected to the class management server 50.

The imaging device 9 captures images of students regularly. Alternatively, the imaging device 9 may capture images of students irregularly or when the students move. Alternatively, the teacher may operate the teacher terminal 10 to request the class management server 50 to capture an image and the imaging device 9 may capture the image in response to a command from the class management server 50.

The imaging device 9 may include a microphone. Voice data collected by the microphone is transmitted to the class management server 50. Alternatively, the microphone may be provided separately from the imaging device 9. For example, the microphone may be disposed on a ceiling or a wall separately from the imaging device 9, or a microphone of the student terminal 30 used by each student may be used. The student's voice is used for, for example, recognizing the student's understanding or gesture.

The teacher terminal 10 may be located where the teacher can operate the teacher terminal 10. However, the teacher terminal 10 is not necessarily within reach of the teacher. For example, only the keyboard and the mouse of the teacher terminal 10 may be located near the teacher while the main body of the teacher terminal 10 may be located in another place. A large-sized display may be located in the classroom separately from the teacher terminal 10 to display the screen displayed on the teacher terminal 10. The teacher terminal 10 does not need to be connected to the communication network N at all times as long as the teacher terminal 10 is connected to the communication network N during class.

The teacher terminal 10 is, for example, an electronic blackboard, which is an example of a device, and performs data communication with the class management server 50 through the communication network N. Instead of an electronic blackboard, the teacher terminal 10 may be a personal computer (PC), a tablet terminal, a personal digital assistant (PDA), a video conference terminal, a wearable PC, a game console, a mobile phone, a car navigation system, or a smartphone. The teacher terminal 10 is not limited to these; as long as a dedicated application runs on a web browser or the class management server 50, the teacher terminal 10 can communicate with the class management server 50.

The teacher terminal 10 can transmit screen data of the teacher terminal 10 to the class management server 50. The teacher terminal 10 can also display screen data of the student terminal 30 transmitted from the class management server 50. The teacher terminal 10 can control the screen displayed on each of the student terminals 30.

For example, during the teacher's lesson, the teacher instructs the students to look at a specific page and the student terminals 30 are fixed to display the page transmitted from the teacher terminal 10. When the teacher permits the display of any page, the students can display any page on the screen of the student terminals 30.

When the teacher terminal 10 simultaneously displays all the screen data displayed on the student terminals 30 and transmitted from the class management server 50, the visibility is reduced especially when many students use the student terminals 30. The teacher terminal 10 can display the screen data from a specific student terminal 30 at a larger size than that of other student terminals 30. The specific student terminal 30 may be, for example, the student terminal 30 of a student selected by the teacher or the student terminal 30 of a student who is speaking.

The student terminal 30 is a terminal device used by a student. The student terminal 30 is preferably located where the student terminal 30 can be operated by the student. For example, the student terminal 30 may be prepared exclusively for the student. Alternatively, the student terminal 30 may be fixed to a desk and exclusively assigned to the student while the student is logged in. The student terminal 30 does not need to be connected to the communication network N at all times as long as the student terminal 30 is connected to the communication network N during class.

The student terminal 30 is, for example, a PC, and performs data communication with the class management server 50 through the communication network N. Instead of a PC, the student terminal 30 may be a tablet terminal, a PDA, or a smartphone. The student terminal 30 is not limited to these; as long as a dedicated application runs on a web browser or the class management server 50, the student terminal 30 can communicate with the class management server 50.

The student terminal 30 can transmit screen data of the student terminal 30 to the class management server 50. The student terminal 30 can also display screen data transmitted from the class management server 50. The screen data transmitted from the class management server 50 is screen data displayed on the teacher terminal 10. The student terminal 30 can display a different screen independently of the teacher terminal 10. For example, when each student's progress varies, the student terminal 30 can display a page of teaching material or subject by the operation of each student. The screen data transmitted to the class management server 50 from the student terminal 30 is, for example, the content of the student's answer or the content of the question.

The class management server 50 can recognize the gesture or face of the student or recognize the speech of the student. The class management server 50 notifies the teacher terminal 10 of the state of each student based on the recognition. The class management server 50 can cause the teacher terminal 10 to display the screen data from the student terminal 30 of the student who performs a specific gesture. The class management server 50 is, for example, one or more information processing devices such as server devices, and can perform data communication with the imaging device 9, the teacher terminal 10, and the student terminals 30 through the communication network N.

The class management server 50 may be installed on premise or in the cloud. Although there is no strict definition of the physical configuration of cloud computing, cloud computing typically involves flexibly adjusting the configuration and installation location of an information processing device. This is achieved by dynamically connecting and disconnecting resources such as a CPU, RAM, and storage, which construct the information processing device, according to the workload.

### Hardware Configuration

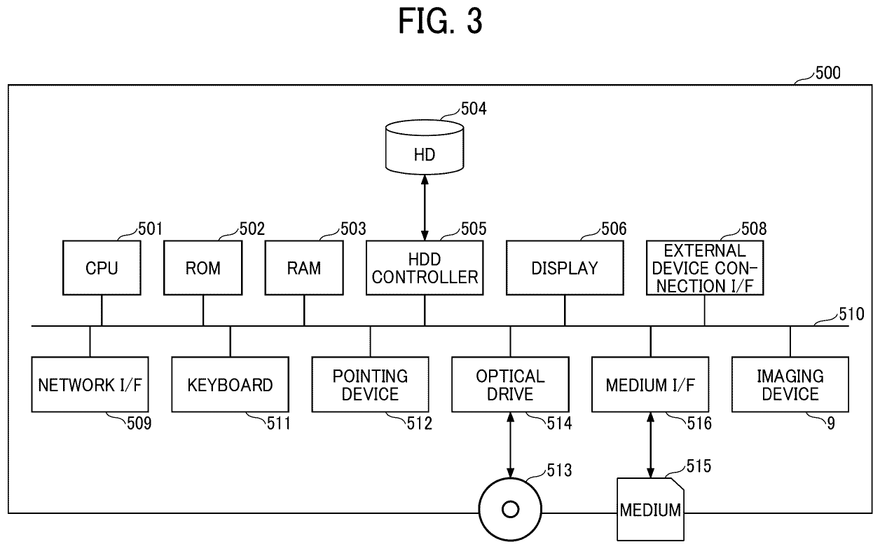

A hardware configuration of the class management server 50, the student terminal 30, or the teacher terminal 10 is described below with reference to FIG. 3. FIG. 3 is a diagram illustrating a hardware configuration of the class management server 50, the student terminal 30, or the teacher terminal 10. As illustrated in FIG. 3, each of the class management server 50, the student terminal 30, and the teacher terminal 10 is implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516. As described above, the teacher terminal 10 further includes the imaging device 9 to capture the images of the students.

The CPU 501 controls the overall operation of the computer 500. The ROM 502 stores programs such as an initial program loader (IPL) to boot the CPU 501. The RAM 503 is used as a work area for the CPU 501. The HD 504 stores various data such as programs. The HDD controller 505 controls the reading or writing of various data to or from the HD 504 under the control of the CPU 501. The display 506 displays various types of information such as the cursor, menus, windows, text, or image data.

The external device connection I/F 508 is an interface for connecting the computer 500 to various external devices. In this case, the external devices include, for example, a universal serial bus (USB) memory stick and a printer. The network I/F 509 is an interface for performing data communication through a network. The bus line 510 is, for example, an address bus or data bus for electrically connecting the components such as the CPU 501 illustrated in FIG. 3.

The keyboard 511 is a type of input device equipped with multiple keys used for entering characters, numbers, and various commands. The pointing device 512 is a type of input device used for selecting and executing various commands, selecting processing targets, and moving the cursor. The optical drive 514 controls the reading or writing of various kinds of data to or from an optical recording medium 513, which is an example of a removable storage medium. The optical recording medium 513 may be, for example, a compact disc (CD), a digital versatile disc (DVD), or a Blu-ray™ disc. The medium I/F 516 controls the reading or writing (storage) of data to or from a recording medium 515 such as flash memory.

### Functions

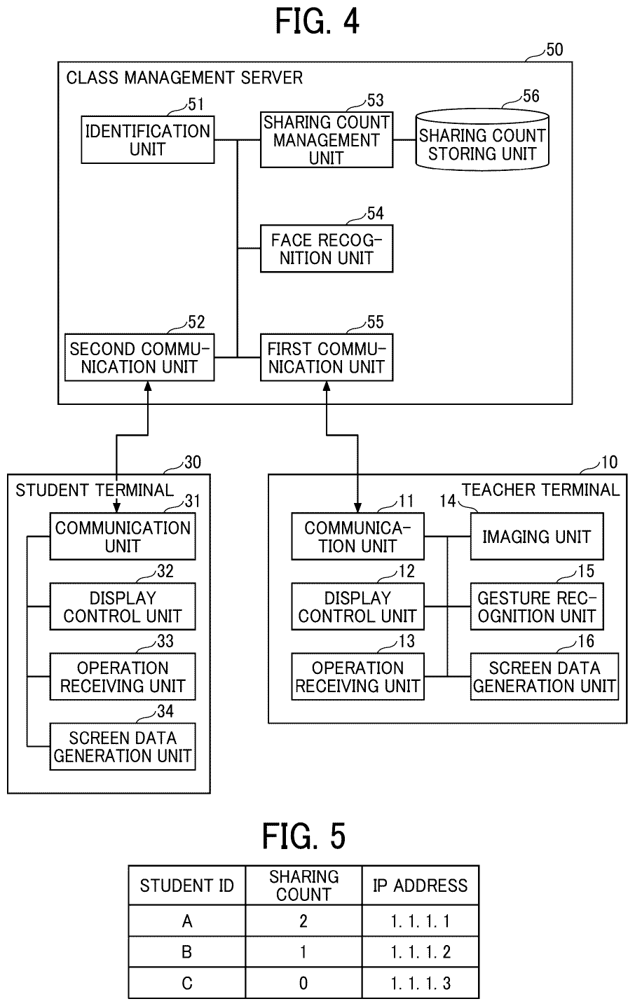

FIG. 4 is a block diagram illustrating a functional configuration of the class management server 50, the student terminal 30, and the teacher terminal 10.

### Teacher Terminal 10

The teacher terminal 10 includes a communication unit 11, a display control unit 12, an operation receiving unit 13, an imaging unit 14, a gesture recognition unit 15, and a screen data generation unit 16. These functional units of the teacher terminal 10 are functions or means of functioning that are implemented by the operation of one or more hardware components illustrated in FIG. 3 in response to instructions of the CPU 501, based on a program deployed from the HD 504 to the RAM 503.

The communication unit 11 connects to the communication network N and communicates with the class management server 50. The communication unit 11 transmits image data captured by the imaging unit 14 or a face image obtained by trimming the face of each student to the class management server 50. The communication unit 11 also receives screen data displayed on the display 506 of the student terminal 30 from the class management server 50.

The communication unit 11 may transmit screen data displayed on the display 506 of the teacher terminal 10 to the class management server 50.

The display control unit 12 displays, on the display 506, the screen data received by the communication unit 11 from the student terminal 30 or teaching materials used for the class. The teaching materials used for the class may be stored in the HD 504 or transmitted from the web server. The operation receiving unit 13 receives operations performed by the teacher on the teacher terminal 10.

The imaging unit 14 captures images of one or more students to generate image data in which the one or more students are depicted. The imaging unit 14 may generate a moving image repeatedly captured at a speed of, for example, 30 fps to 60 fps, or may generate a still picture. The imaging unit 14 may capture an image only when the image has a motion of a certain level or more.

The gesture recognition unit 15 recognizes the gestures of one or more students from the image data captured by the imaging unit 14. One approach to recognizing gestures from screen data uses a machine learning model. This model outputs what kind of gestures the input image data indicates, together with the probability of the gestures. The gestures that are recognized include raising a hand.

For example, it is assumed that the image data and the type of gesture are associated with each other by a model generated by machine learning such as deep learning. As a model for determining a motion from image data, the joint coordinates of a person may be estimated from the image data and associated with the motion. In other words, the gesture recognition unit 15 obtains the joint coordinates by using an existing model for detecting joint coordinates (motion) from image data. The gesture recognition unit 15 prepares a model for inputting the joint coordinates (motion) and outputting the type of gesture by machine learning to analyze the gesture of a student raising their hand with high accuracy.

The gesture recognition unit 15 recognizes the gesture of raising a hand and also detects the human face. The gesture recognition unit 15 does not necessarily recognize whose face is captured, only that the gesture recognition unit 15 detects a student's face. The class management server 50 identifies the individuals. Alternatively, the teacher terminal 10 may recognize individual students. A Haar-like feature, a convolutional neural network (CNN), or a You Only Look Once (YOLO) may be used to detect faces. The gesture recognition unit 15 trims an area including a face to generate a face image.

The screen data generation unit 16 captures a screen displayed on the display 506 of the teacher terminal 10 in real time to generate screen data currently displayed on the teacher terminal 10. The screen data is transmitted to the student terminal 30 through the class management server 50 mainly while the teacher is speaking.

The class management server 50 may include the imaging unit 14 and the gesture recognition unit 15 among the components of the teacher terminal 10 illustrated in FIG. 4. In other words, the teacher terminal 10 may have a part or all of the configuration of the class management server 50.

### Class Management Server 50

The class management server 50 includes an identification unit 51, a second communication unit 52, a sharing count management unit 53, a face recognition unit 54, and a first communication unit 55. These functional units of the class management server 50 are functions or means of functioning that are implemented by the operation of one or more hardware components illustrated in FIG. 3 in response to instructions of the CPU 501, based on a program deployed from the HD 504 to the RAM 503. The class management server 50 includes a sharing count storing unit 56 implemented by the HD 504 or the RAM 503 illustrated in FIG. 3. The class management server 50 may not include the sharing count storing unit 56 as long as the sharing count storing unit 56 is placed in a location accessible to the class management server 50 through the communication network N.

The first communication unit 55 connects to the communication network N and receives a face image from the teacher terminal 10. The first communication unit 55 transmits the screen data received from the student terminal 30 to the teacher terminal 10.

The face recognition unit 54 is means of facial recognition by analyzing face images transmitted from the teacher terminal 10. The face recognition unit 54 may identify a student who performs the gesture of raising their hand again. The face recognition unit 54 registers the features of the face of each student to identify each student or name by, for example, pattern matching. Student IDs are obtained by the identification.

The machine learning model may be used for such a face recognition function. Image data has sufficient resolution to allow analysis of a student's face.

The face recognition unit 54 recognizes (identifies) a student with a model in which the features of image data and student IDs are associated with each other in advance by machine learning such as deep learning. The features of image data in face recognition are relative positions of face parts that can be detected, such as an eyebrow, a pupil, a nostril, a tip of a nose, a corner of a mouth, and a mouth. The face recognition unit 54 extracts features from the face of a student who performs the gesture of raising their hand and inputs the features into the model to output the student ID.

The sharing count management unit 53 stores the sharing count in the sharing count storing unit 56. In other words, the sharing count management unit 53 stores, in the sharing count storing unit 56, the number of times the teacher terminal 10 has shared the screen data from the student. The sharing count storing unit 56 will be described later with reference to FIG. 5.

The identification unit 51 refers to the sharing count information and determines the student who has shared screen data the least number of times among the students who perform the gesture of raising their hands. The teacher terminal 10 shares the screen data displayed on the student terminal 30 of the student.

The second communication unit 52 requests the screen data from the student terminal 30 determined by the identification unit 51 and receives the screen data from the student terminal 30. Then, the first communication unit 55 transmits the screen data to the teacher terminal 10.

The teacher terminal 10 may include the identification unit 51, the sharing count management unit 53, and the face recognition unit 54 among the components of the class management server 50 illustrated in FIG. 4. In other words, the class management server 50 may have a part or all of the configuration of the teacher terminal 10.

### Student Terminal 30

The student terminal 30 includes a communication unit 31, a display control unit 32, an operation receiving unit 33, and a screen data generation unit 34. These functional units of the teacher terminal 10 are functions or means of functioning that are implemented by the operation of one or more hardware components illustrated in FIG. 3 in response to instructions of the CPU 501, based on a program deployed from the HD 504 to the RAM 503.

The communication unit 31 connects to the communication network N and communicates with the class management server 50. The communication unit 31 transmits screen data displayed on the display 506 to the class management server 50 in response to a request from the class management server 50 or as needed. The functions of the display control unit 32, the operation receiving unit 33, and the screen data generation unit 34 may be substantially the same as those of the teacher terminal 10.

### Sharing Count Storing Unit

FIG. 5 illustrates the sharing count information stored in the sharing count storing unit 56. The sharing count information stores the number of times the screen data displayed on the student terminal 30 is shared by the teacher terminal 10 in association with the student ID.

“Student ID” is the identification information of a student. When a student uses a single student terminal 30, the student ID may be regarded as the identification information of the student terminal 30.

“Sharing count” is the number of times the screen data displayed on the student terminal 30 is shared by the teacher terminal 10. In this case, “shared” means being displayed on the teacher terminal 10. The sharing count may be the number of times in the entire past period in which the history can be obtained or the number of times in the latest certain period such as one month, one week, or half a year.

“IP address” is the Internet Protocol (IP) address of each of the student terminals 30 registered when the students log in to the class management server 50. The class management server 50 can communicate with any student terminal 30 with the IP address as a destination.

### Specific Example of Screen Sharing

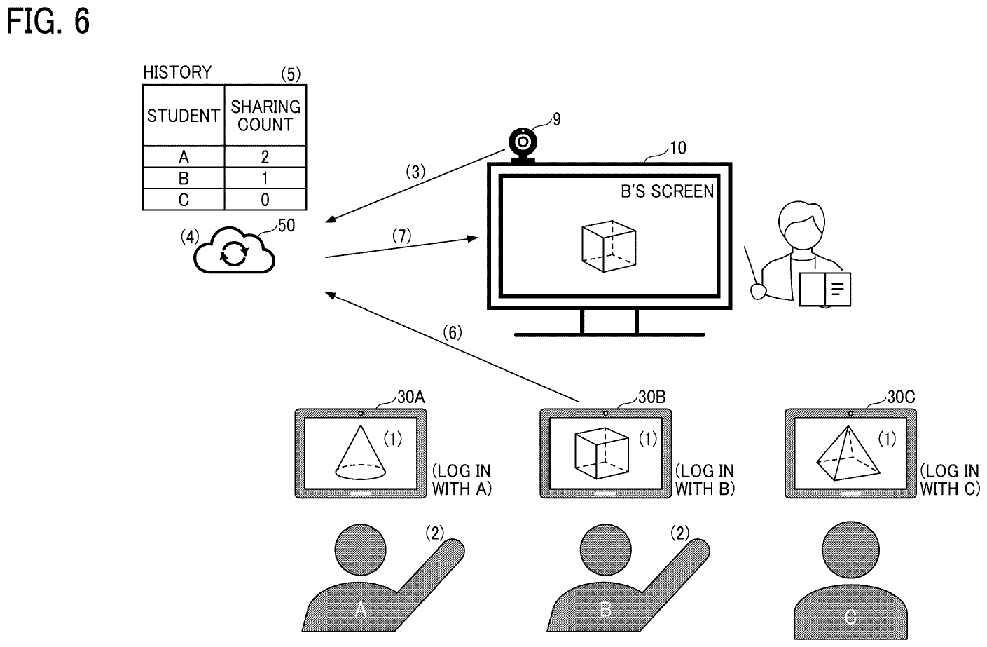

A method for determining the student terminal 30 as a sharing source based on the sharing count information is described below with reference to FIG. 6. FIG. 6 is a schematic diagram illustrating a process in which the class management server 50 determines which student terminal 30 is to share screen data with the teacher terminal 10 and shares the screen data from the determined student terminal 30.
(1) For example, a teacher asks a question, and students input their answers into their respective student terminals 30A to 30C. Each of the student terminals 30A to 30C displays the answer input by the student.
(2) When the teacher says, ‘Raise your hand if you have an answer,’ the students who input their answers raise their hands. The imaging device 9 repeatedly captures images of the students. Thus, the image data includes the students who perform the gesture of raising their hands. In FIG. 6, the students A and B raise their hands.
(3) The teacher terminal 10 recognizes the gesture of raising a hand and transmits the face image of the student who raises their hand to the class management server 50.
(4) The class management server 50 identifies the student ID by recognizing the face of the student in the face image and determines that the students A and B perform the gesture of raising their hands.
(5) The identification unit 51 refers to the sharing count information and finds that the sharing count of the student A who raises their hand is 2 while the sharing count of the student B who raises their hand is 1. The identification unit 51 determines to share the image data displayed on the student terminal 30B with the lowest sharing count, to reduce the bias in the sharing count.
(6) The class management server 50 requests the screen data from the student terminal 30B. The student terminal 30B transmits the screen data to the class management server 50 in response to the request. The screen data includes an answer.
(7) The class management server 50 transmits the screen data received from the student terminal 30B to the teacher terminal 10. The teacher terminal 10 displays, on the display 506, the screen data received from the student terminal 30B. In FIG. 6, the teacher terminal 10 displays the screen data from the student terminal 30B.

### Operations or Processes

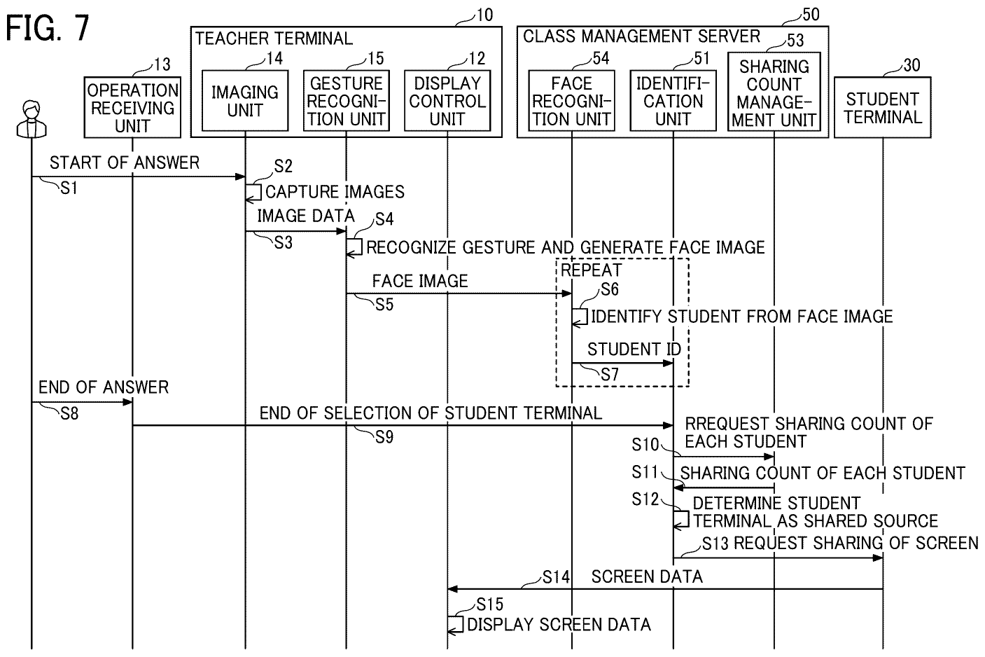

FIG. 7 is a sequence diagram illustrating a process in which the class management server 50 determines which student terminal 30 is to share screen data with the teacher terminal 10 and causes the teacher terminal 10 to share the screen data from the determined student terminal 30.

In step S1, the teacher asks students a question, and the students input their answers into their respective student terminals 30. The answer is reflected in the screen data. In other words, the answer is displayed. The teacher inputs the start of the answer into the teacher terminal 10. Alternatively, the teacher may set a time limit in advance when asking the students a question and input the time limit into the teacher terminal 10.

In step S2, the operation receiving unit 13 of the teacher terminal 10 receives the operation of the start of answering, and the imaging unit 14 causes the imaging device 9 to repeat capturing images of the multiple students. The image capturing may be performed at all times.

In step S3, the imaging unit 14 transmits the image data to the gesture recognition unit 15.

In step S4, the gesture recognition unit 15 analyzes the image data and identifies a gesture. At least the gesture of raising a hand is detected. For example, the teacher says, ‘Raise your hand if you have an answer,’ and students who input their answers raise their hands.

In step S5, the gesture recognition unit 15 cuts out the face images of all the students who perform the gesture of raising their hands. The communication unit 11 of the teacher terminal 10 transmits all the face images to the class management server 50. The communication unit 11 does not necessarily transmit all the face images at the same time. The communication unit 11 may transmit the face image each time the gesture of raising a hand is recognized.

In step S6, the first communication unit 55 of the class management server 50 receives the face image of the student who performs the gesture of raising their hand. When the face image is received, the face recognition unit 54 analyzes the face image and identifies the student. In a case where the students do not necessarily raise their hands at the same time, each student who raises their hands before the teacher inputs the end of the answer of the student terminal 30 into the teacher terminal 10 or within the time limit set by the teacher is identified. The face recognition unit 54 identifies all the students who raise their hands before the end of the answer or the time limit.

In step S7, the face recognition unit 54 transmits the identified student ID to the identification unit 51. The actions of steps S6 and S7 are repeatedly executed.

In step S8, the teacher inputs the end of the answer to the teacher terminal 10. When the time limit is set, the operation for the end of the answer is not necessary.

In step S9, the operation receiving unit 13 receives the operation, and the communication unit 11 transmits the end of the selection of the student terminal 30 to the class management server 50.

In step S10, the identification unit 51 requests the sharing count associated with the student ID from the sharing count management unit 53 in response to the first communication unit 55 receiving the end of the selection of the student terminal 30. In step S11, the identification unit 51 acquires the sharing count from the sharing count management unit 53.

In step S12, the identification unit 51 determines to share the screen data of the student terminal 30 of a student with the lowest sharing count among the students who raise their hands.

In step S13, the identification unit 51 designates, for example, the IP address of the determined student terminal 30 and requests the second communication unit 52 to share the screen data. The second communication unit 52 requests the screen data from the student terminal 30 determined by the identification unit 51. The sharing count management unit 53 acquires the student ID determined by the identification unit 51 from the identification unit 51 and increments the sharing count of the student in the sharing count storing unit 56 by one.

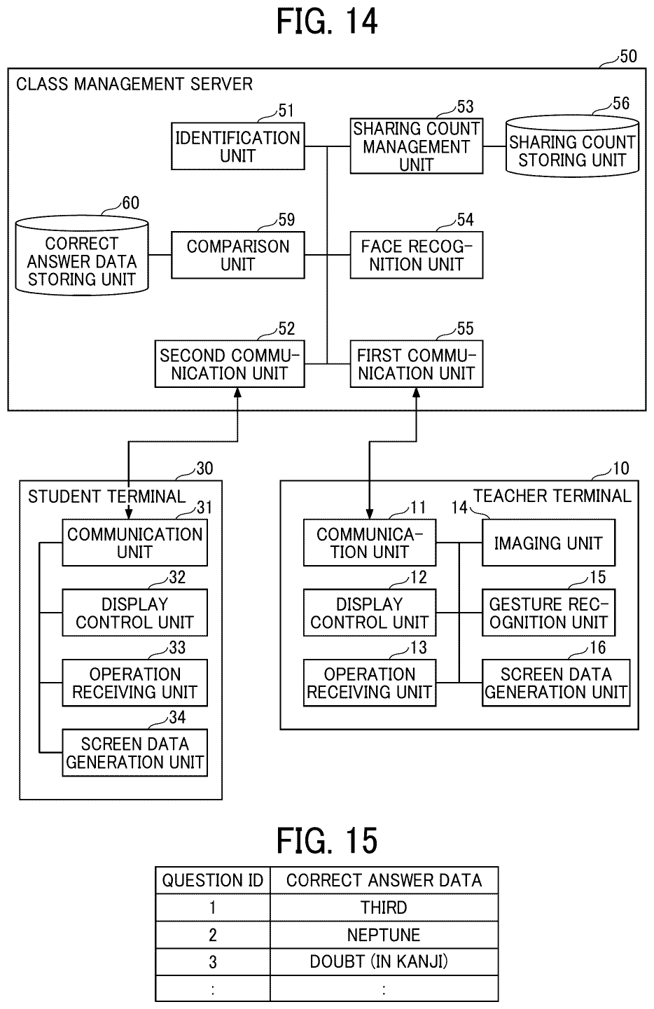

In step S14, when the communication unit 31 of the student terminal 30 receives the request for screen data, the screen data generation unit 16 captures the information displayed on the display 506 and generates screen data. The communication unit 31 of the student terminal 30 transmits the screen data to the teacher terminal 10 through the class management server 50. The screen data is captured to acquire the handwritten content when the answer is handwritten. Depending on the form of the answer such as multiple-choice options or digital data, the screen data may not be captured. In the present embodiment, the answer including options or digital data is acquired by the capture. FIG. 15 illustrates an example of the answer (correct answer data).

In step S15, when the communication unit 11 of the teacher terminal 10 receives the screen data, the communication unit 11 transmits the screen data to the display control unit 12. The display control unit 12 of the teacher terminal 10 causes the display 506 to display the screen data transmitted from the student terminal 30.

In the present embodiment, the condition for sharing the screen data is the student's hand-raising. Alternatively, the teacher may designate any student terminal 30 and the screen data of the student terminal 30 may be shared with the teacher terminal 10. Alternatively, the teacher terminal 10 may acquire screen data from all the student terminals 30 and the teacher may select one of the student terminals 30 to share the screen data. For example, the teacher may use the screen data to introduce a typical incorrect answer or to grasp the understanding of each student.

As described above, the class management server 50 determines the student terminal 30 with the lowest sharing count with reference to the sharing count information to reduce the bias in selecting the student terminal 30 to share the screen data with the teacher terminal 10.

### Second Embodiment

The information sharing system 100 for displaying, on the teacher terminal 10, students in the order in which the students raise their hands is described below.

### Functions

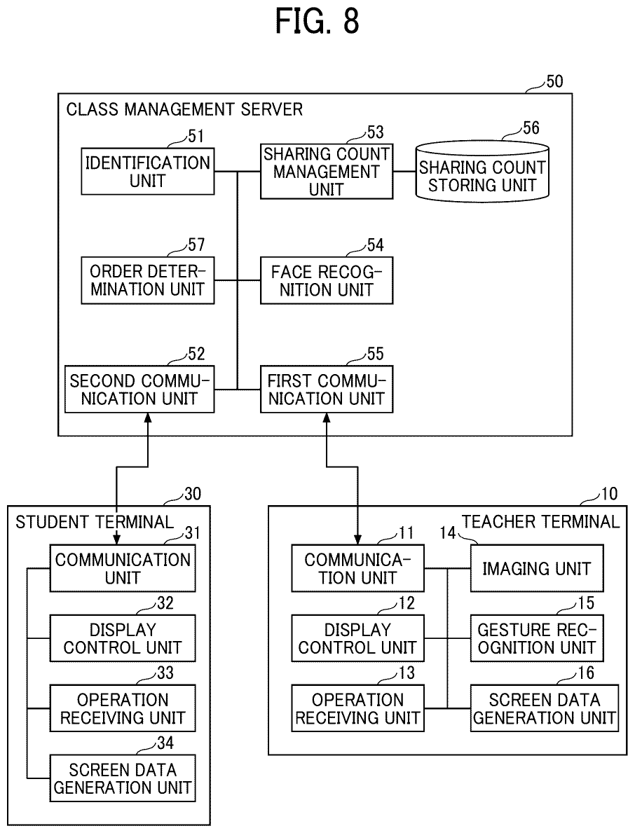

FIG. 8 is a block diagram illustrating a functional configuration of the class management server 50, the student terminal 30, and the teacher terminal 10. The difference from FIG. 4 is that the class management server 50 illustrated in FIG. 8 further includes an order determination unit 57. The order determination unit 57 determines the order of the students who raise their hands, sorted by who raises their hand first.

### Specific Example of Screen Sharing

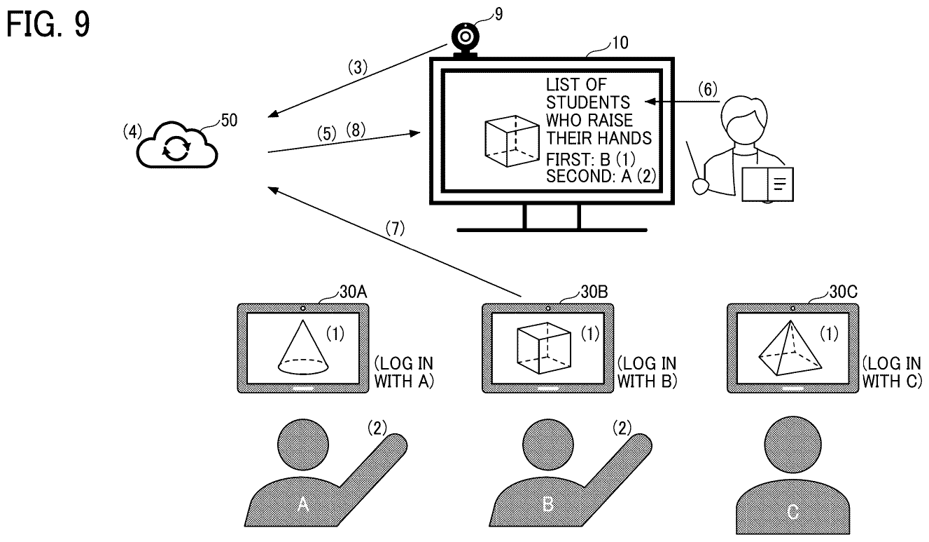

An example of displaying students in the order in which they raise their hands is described below with reference to FIG. 9. FIG. 9 is a schematic diagram illustrating a process in which the class management server 50 displays students in the order in which the students raise their hands. The teacher selects which of the student terminals 30 is to share the screen data with the teacher terminal 10. However, the screen data of the student terminal 30 with the lowest sharing count may be shared with the teacher terminal 10 as in the first embodiment.
(1) For example, a teacher asks a question, and students input their answers into their respective student terminals 30A to 30C. Each of the student terminals 30A to 30C displays the answer input by the student.
(2) When the teacher says, ‘Raise your hand if you have an answer,’ the students who input their answers raise their hands. The imaging device 9 repeatedly captures images of the students. Thus, the image data includes the students who perform the gesture of raising their hands. In FIG. 9, the students A and B raise their hands.
(3) The teacher terminal 10 recognizes the gesture of raising a hand and transmits the face image of the student who raises their hand to the class management server 50.
(4) The class management server 50 identifies the student ID by recognizing the face of the student in the face image, and first determines that the student B performs the gesture of raising their hand. The order determination unit 57 determines that the student B is the first to raise their hand. Subsequently, the class management server 50 recognizes the face of the student in the face image and determines that the student A performs the gesture of raising their hand. The order determination unit 57 determines that the student A is the second to raise their hand.
(5) The class management server 50 associates the students A and B with the order in which the students A and B raise their hands and transmits the associated information to the teacher terminal 10 each time the class management server 50 performs the association. Thus, the teacher terminal 10 displays a list of students who raise their hands along with the order in which the students raise their hands. The identification unit 51 may refer to the sharing count information and display, in the list of students who raise their hands, the sharing counts of the students A and B who raise their hands. The teacher can select a student with the lowest sharing count.
(6) The teacher selects a student with reference to the sharing count. For example, the student terminal 30B is selected.
(7) The class management server 50 requests the screen data from the student terminal 30B. The student terminal 30B transmits the screen data to the class management server 50 in response to the request.
(8) The class management server 50 transmits the screen data received from the student terminal 30B to the teacher terminal 10. The teacher terminal 10 displays the screen data on the display 506. In FIG. 9, the teacher terminal 10 displays the screen data from the student terminal 30B.

### Operations or Processes

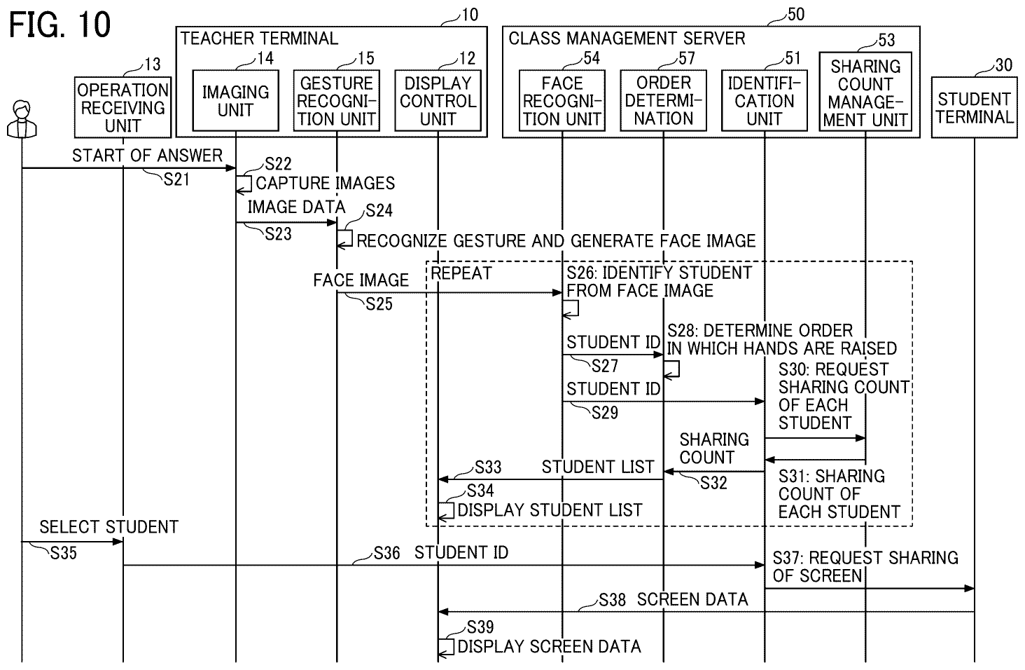

FIG. 10 is a sequence diagram illustrating a process in which the class management server 50 determines the order of students who raise their hands and the teacher terminal 10 displays a list of students who raise their hands, ordered by the time the students raise their hands, along with the sharing count. The differences from FIG. 7 are described below with reference to FIG. 10. The actions of steps S21 to S26 may be the same as those of steps S1 to S6 in FIG. 7. The actions of steps S26 to S34 are repeatedly executed.

In step S26, the first communication unit 55 of the class management server 50 receives the face image of the student who performs the gesture of raising their hand. When the face image is received, the face recognition unit 54 analyzes the face image and identifies the student. The face recognition unit 54 repeatedly identifies all the students who raise their hands until the teacher selects a student from the student list or the time limit.

In step S27, the face recognition unit 54 transmits the identified student ID to the order determination unit 57.

In step S28, the order determination unit 57 determines the order in which the students raise their hands, sorted by whose student ID is received first, and associates the order with the student ID.

In step S29, the face recognition unit 54 transmits the identified student ID to the identification unit 51.

In step S30, the identification unit 51 requests the sharing count associated with the student ID from the sharing count management unit 53. In step S31, the identification unit 51 acquires the sharing count from the sharing count management unit 53.

In step S32, the identification unit 51 transmits the sharing count of the student who raises their hand to the order determination unit 57.

In step S33, the order determination unit 57 generates a student list in which each student is associated with the sharing count and the order in which the students raise their hands, and the first communication unit 55 transmits the student list to the teacher terminal 10. In this way, each time the order determination unit 57 associates the order in which the students raise their hands with the student ID, the first communication unit 55 transmits the student list to the teacher terminal 10.

In step S34, when the communication unit 11 of the teacher terminal 10 receives the student list, the communication unit 11 transmits the received student list to the display control unit 12. The display control unit 12 causes the display 506 to display the student list.

In step S35, the teacher inputs an operation to select a student from the student list. Instead of the teacher selecting a student, the teacher may input the end of the answer and a student with the lowest sharing count may be selected as in the first embodiment. When a student with the lowest sharing count is selected and the time limit is set, the operation for the end of the answer is not necessary.

In step S36, the operation receiving unit 13 receives the operation, and the communication unit 11 transmits the selected student ID to the class management server 50.

In step S37, the first communication unit 55 of the class management server 50 receives the student ID, and the identification unit 51 designates, for example, the IP address of the student terminal 30 identified by the student ID and requests the second communication unit 52 to share the screen data. The second communication unit 52 requests the screen data from the student terminal 30 identified by the identification unit 51. The sharing count management unit 53 increments the sharing count of the student in the sharing count storing unit 56 by one based on the received student ID. The subsequent steps S38 and S39 may be the same as steps S14 and S15 in FIG. 7.

According to the present embodiment, in addition to one aspect of the first embodiment, the teacher terminal 10 can display the students who raise their hands in the order in which the students raise their hands, in association with the sharing count. The teacher can select a student with the lowest sharing count with reference to the displayed order or sharing count of the students.

### Third Embodiment

The information sharing system 100 for displaying a student list in ascending order of sharing count is described below.

### Functions

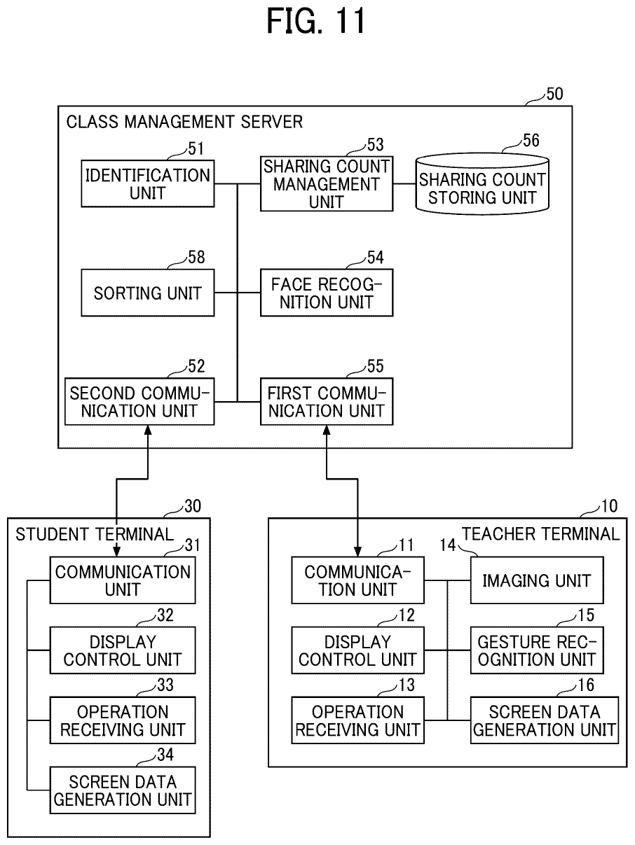

FIG. 11 is a block diagram illustrating a functional configuration of the class management server 50, the student terminal 30, and the teacher terminal 10. The difference from FIG. 4 is that the class management server 50 illustrated in FIG. 11 further includes a sorting unit 58. The sorting unit 58 sorts the students who perform the gesture of raising their hands in ascending order of sharing count.

### Specific Example of Screen Sharing

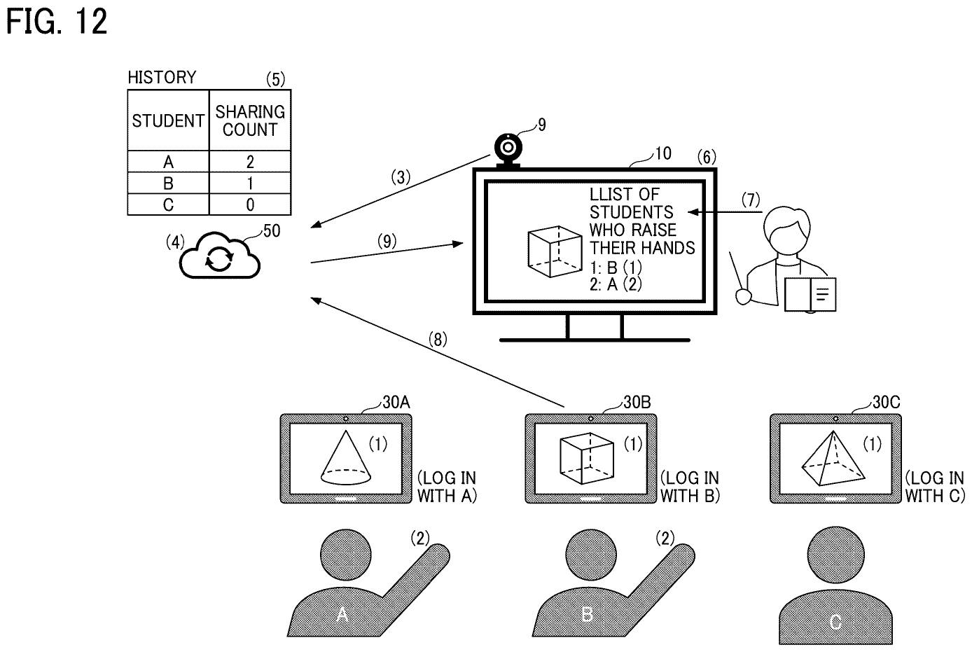

An example of displaying the sharing count is described below with reference to FIG. 12. FIG. 12 is a schematic diagram illustrating a process in which the teacher terminal 10 displays a list of students who raise their hands in ascending order of sharing count. The teacher selects which of the student terminals 30 is to share the screen data with the teacher terminal 10. However, the screen data of the student terminal 30 with the lowest sharing count may be shared with the teacher terminal 10 as in the first embodiment.
(1) For example, a teacher asks a question, and students input their answers into their respective student terminals 30A to 30C. Each of the student terminals 30A to 30C displays the answer input by the student.
(2) When the teacher says, ‘Raise your hand if you have an answer,’ the students who input their answers raise their hands. The imaging device 9 repeatedly captures images of the students. Thus, the image data includes the students who perform the gesture of raising their hands. In FIG. 12, the students A and B raise their hands.
(3) The teacher terminal 10 recognizes the gesture of raising a hand and transmits the face image of the student who raises their hand to the class management server 50.
(4) The class management server 50 identifies the student ID by recognizing the face of the student in the face image and determines that the students A and B perform the gesture of raising their hands.
(5) The identification unit 51 refers to the sharing count information and finds that the sharing count of the student A who raises their hand is 2 while the sharing count of the student B who raises their hand is 1. The sorting unit 58 sorts the students in ascending order of sharing count and generates a student list in the sorted order.
(6) Each time the number of students who raise their hands increases, the class management server 50 transmits the student list to the teacher terminal 10, and the teacher terminal 10 displays the student list. Thus, the teacher terminal 10 displays the student list in ascending order of sharing count.
(7) The teacher selects a student with reference to the displayed order based on the sharing count. For example, the student terminal 30B is selected.
(8) The class management server 50 requests the screen data from the student terminal 30B. The student terminal 30B transmits the screen data to the class management server 50 in response to the request.
(9) The class management server 50 transmits the screen data received from the student terminal 30B to the teacher terminal 10. The teacher terminal 10 displays the screen data on the display 506. In FIG. 12, the teacher terminal 10 displays the screen data from the student terminal 30B.

### Operations or Processes

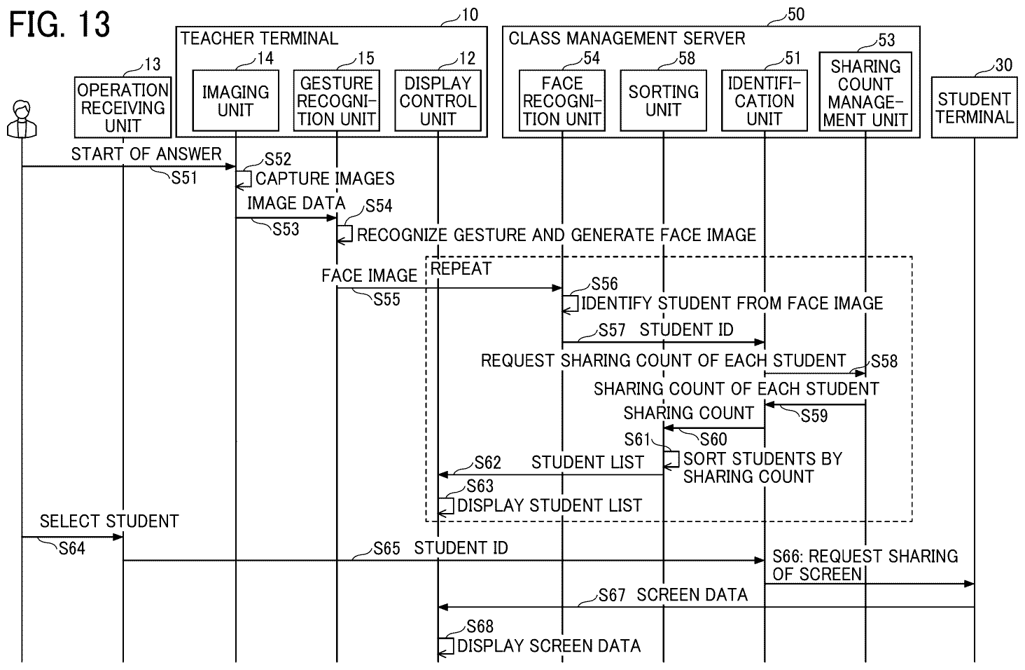

FIG. 13 is a sequence diagram illustrating a process in which the class management server 50 sorts students by the sharing count of the students who raise their hands and the teacher terminal 10 displays a list of students who raise their hands in ascending order of sharing count. The differences from FIG. 7 are described below with reference to FIG. 13. The actions of steps S51 to S56 may be the same as those of steps S1 to S6 in FIG. 7. The actions of steps S56 to S63 are repeatedly executed.

In step S56, the first communication unit 55 of the class management server 50 receives the face image of the student who performs the gesture of raising their hand. When the face image is received, the face recognition unit 54 analyzes the face image and identifies the student. The face recognition unit 54 repeatedly identifies all the students who raise their hands until the teacher selects a student from the student list or the time limit.

In step S57, the face recognition unit 54 transmits the identified student ID to the identification unit 51.

In step S58, the identification unit 51 requests the sharing count associated with the student ID from the sharing count management unit 53. In step S59, the identification unit 51 acquires the sharing count from the sharing count management unit 53.

In step S60, the identification unit 51 transmits the sharing count of the student who raises their hand to the sorting unit 58.

In step S61, the sorting unit 58 sorts the students who raise their hands by the sharing count. The sorting unit 58 repeatedly sorts the students each time the number of students who raise their hands increases.

In step S62, the sorting unit 58 transmits a student list displaying the students in the sorted order to the first communication unit 55. The student list may include the sharing count. The first communication unit 55 transmits the student list to the teacher terminal 10.

In step S63, when the communication unit 11 of the teacher terminal 10 receives the student list, the communication unit 11 transmits the received student list to the display control unit 12. The display control unit 12 causes the display 506 to display the student list.

In step S64, the teacher confirms the students displayed in ascending order of sharing count and inputs an operation to select a student into the teacher terminal 10. Instead of the teacher selecting a student, the teacher may input the end of the answer and a student with the lowest sharing count may be selected as in the first embodiment. When a student with the lowest sharing count is selected and the time limit is set, the operation for the end of the answer is not necessary.

In step S65, the operation receiving unit 13 receives the operation, and the communication unit 11 transmits the selected student ID to the class management server 50.

In step S66, the first communication unit 55 of the class management server 50 receives the student ID, and the identification unit 51 designates, for example, the IP address of the student terminal 30 identified by the student ID and requests the second communication unit 52 to share the screen data. The second communication unit 52 requests the screen data from the student terminal 30 determined by the identification unit 51. The sharing count management unit 53 increments the sharing count of the student in the sharing count storing unit 56 by one based on the received student ID.

The subsequent steps S67 and S68 may be the same as steps S14 and S15 in FIG. 7.

According to the present embodiment, in addition to one aspect of the first embodiment, the teacher terminal 10 can display the students who raise their hands in ascending order of sharing count. The teacher can select a student with the lowest sharing count from the student list displayed in ascending order of sharing count with reference to the displayed order.

### Fourth Embodiment

The information sharing system 100 is described below in which the screen data of students who raise their hands are compared with correct answer data and the teacher terminal 10 displays the screen data of a student with the highest similarity to the correct answer data.

### Functions

FIG. 14 is a block diagram illustrating a functional configuration of the class management server 50, the student terminal 30, and the teacher terminal 10. The difference from FIG. 4 is that the class management server 50 illustrated in FIG. 14 further includes a comparison unit 59 and a correct answer data storing unit 60.

The comparison unit 59 compares the answer (screen data) transmitted from the student terminal 30 of the student who performs the gesture of raising their hand with the correct answer data stored in the correct answer data storing unit 60 and calculates the similarity. The identification unit 51 determines the student terminal 30 that transmits the answer with the highest similarity as the student terminal 30 from which the screen data is to be displayed on the teacher terminal 10.

FIG. 15 is a schematic diagram illustrating correct answer data information stored in the correct answer data storing unit 60. The correct answer data information stores question IDs and correct answer data in association with each other. “Question ID” indicates the identification information of a question. “Correct answer data” indicates a model answer to the question. The correct answer data is in the form of, for example, multiple-choice options, digital data, or raster data (image data). Multiple-choice options represent the numbered choices available when selecting an answer from a set of multiple choices. Answers in digital data are answers input in digital form in writing tests. “Neptune” is the correct answer data of a question about what the outermost planet is. Answers in raster data are answers input by handwriting in writing tests. “Doubt (in kanji)” is the correct answer data of a question that requires converting “doubt (in hiragana)” into kanji. Hiragana and kanji are Japanese writing systems. Answers in raster data may be answers in any other data handwritten by the users, such as drawings, mathematical expressions, or handwritten English words. The comparison unit 59 compares the answers with the correct answer data according to the form of the correct answer data.

### Specific Example of Screen Sharing

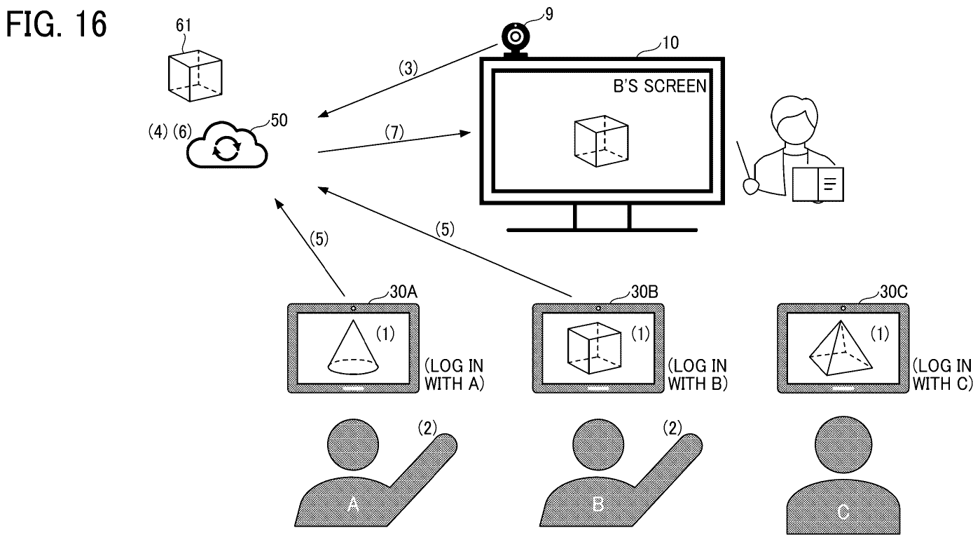

A method for determining a terminal to be shared, based on the similarity between correct answer data and answers, is described below with reference to FIG. 16. FIG. 16 is a schematic diagram illustrating a process in which the class management server 50 compares an answer input into the student terminal 30 by each student who raises their hand with correct answer data and determines the student terminal 30 for sharing screen data.
(1) For example, a teacher asks a question, and students input their answers into their respective student terminals 30A to 30C. Each of the student terminals 30A to 30C displays the answer input by the student.
(2) When the teacher says, ‘Raise your hand if you have an answer,’ the students who input their answers raise their hands. The imaging device 9 repeatedly captures images of the students. Thus, the image data includes the students who perform the gesture of raising their hands. In FIG. 16, the students A and B raise their hands.
(3) The teacher terminal 10 recognizes the gesture of raising a hand and transmits the face image of the student who raises their hand to the class management server 50.
(4) The class management server 50 identifies the student ID by recognizing the face of the student in the face image and determines that the students A and B perform the gesture of raising their hands.
(5) The class management server 50 requests the screen data from the student terminals 30A and 30B associated with the identified students A and B, respectively. The student terminals 30A and 30B transmit screen data to the class management server 50 as answers.
(6) The class management server 50 compares the screen data received from each of the student terminals 30A and 30B with correct answer data 61 and calculates the similarity. The class management server 50 determines to share the screen data of the student terminal 30 with a similarity equal to or greater than a threshold. When multiple student terminals 30 display screen data with a similarity to the correct answer data equal to or greater than the threshold, the class management server 50 may determine to share the screen data from the student terminal 30 with the lowest sharing count, or the teacher may select one of the student terminals 30. In FIG. 16, the student terminal 30B is determined as the sharing source.
(7) The class management server 50 transmits the screen data received from the student terminal 30B to the teacher terminal 10. The teacher terminal 10 displays the screen data on the display 506. In FIG. 16, the teacher terminal 10 displays the screen data from the student terminal 30B.

### Operations or Processes

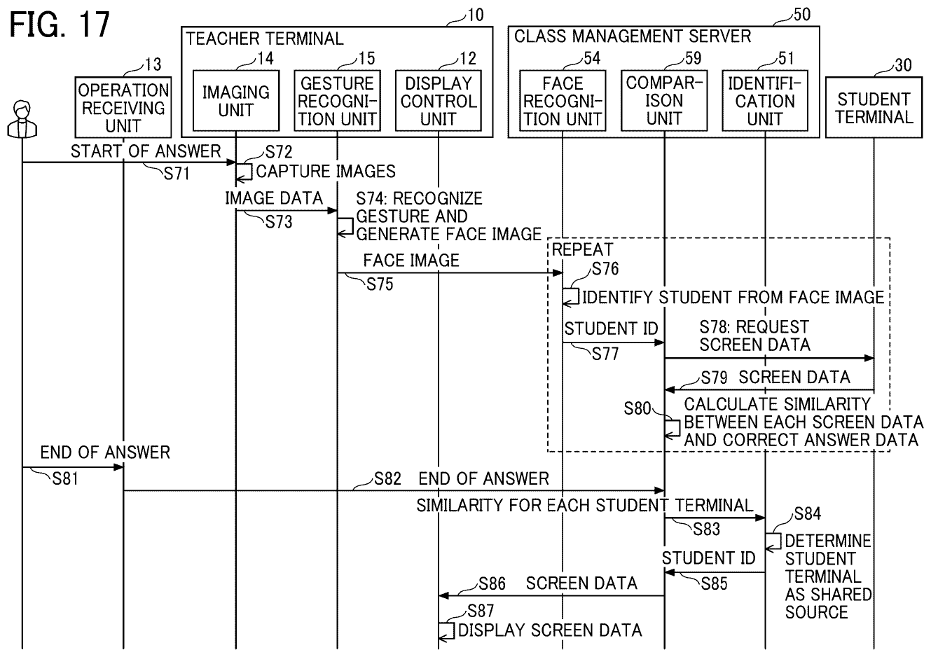

FIG. 17 is a sequence diagram illustrating a process in which the class management server 50 determines the student terminal 30 to be shared with the teacher terminal 10 based on the similarity and shares the screen data from the determined student terminal 30. The differences from FIG. 7 are described below with reference to FIG. 17. The actions of steps S71 to S76 may be the same as those of steps S1 to S6 in FIG. 7. The actions of steps S76 to S80 are repeatedly executed.

In step S76, the first communication unit 55 of the class management server 50 receives the face image of the student who performs the gesture of raising their hand. When the face image is received, the face recognition unit 54 analyzes the face image and identifies the student. The face recognition unit 54 repeatedly identifies all the students who raise their hands until the teacher inputs the end of the answer or the time limit.

In step S77, the face recognition unit 54 transmits the student ID identified by recognizing the face image to the comparison unit 59.

In step S78, when the comparison unit 59 receives the student ID, the comparison unit 59 requests, through the second communication unit 52, screen data from the student terminal 30 identified by the student ID.

In step S79, when the communication unit 31 of the student terminal 30 receives the request for screen data, the communication unit 31 transmits the screen data to the class management server 50. The second communication unit 52 receives the screen data and transmits the screen data to the comparison unit 59.

In step S80, the comparison unit 59 calculates the similarity between the screen data (answer) transmitted from the student terminal 30 and the correct answer data. In the case of multiple-choice options, the similarity is 0 or 100. In the case of digital data, the similarity may be a ratio of the number of characters matching the answer to the character string of the correct answer. In the case of raster data, the similarity is obtained by pattern matching. For example, the maximum similarity is 100 points.

The class management server 50 may transmit the list of students sorted in descending order of similarity to the teacher terminal 10. Alternatively, the class management server 50 may transmit the list of students sorted in two or more of the descending order of similarity, the order in which the students raise their hands, and the ascending order of sharing count to the teacher terminal 10. By displaying the student list, the teacher can select a student with reference to the displayed order.

In step S81, the teacher inputs an operation to close the answer to the teacher terminal 10. When the time limit is set, the operation for the end of the answer is not necessary.

In step S82, the operation receiving unit 13 receives the operation, and the communication unit 11 transmits the end of the answer to the class management server 50.

In step S83, when the first communication unit 55 of the class management server 50 receives the end of the answer, the comparison unit 59 transmits the similarity for each of the student terminals 30 of the students who raise their hands to the identification unit 51.

In step S84, the identification unit 51 determines to share the screen data of the student terminal 30 with a similarity equal to or greater than a threshold. When multiple student terminals 30 with a similarity equal to or greater than the threshold are present, the identification unit 51 refers to the sharing count and determines to share the screen data from the student terminal 30 with the lowest sharing count. Alternatively, the student terminal 30 of the student who raises their hand the earliest or the student selected by the teacher may be selected. The sharing count management unit 53 increments the sharing count of the student in the sharing count storing unit 56 by one based on the student ID identified by the identification unit 51.

In step S85, the identification unit 51 transmits the student ID of the determined student terminal 30 to the comparison unit 59.

In step S86, the comparison unit 59 transmits the screen data from the student terminals 30 identified by the student ID to the teacher terminal 10 through the first communication unit 55.

In step S87, when the communication unit 11 of the teacher terminal 10 receives the screen data, the communication unit 11 transmits the screen data to the display control unit 12. The display control unit 12 of the teacher terminal 10 causes the display 506 to display the screen data transmitted from the student terminal 30.

Although the screen data from the student terminal 30 of the student who has a correct answer is shared, the teacher terminal 10 may display the screen data from the student terminal 30 determined to be not similar by the comparison unit 59. The teacher can grasp the tendency of the way of mistake and instruct the students to correct any points of misunderstanding.

According to the present embodiment, in addition to one aspect of the first embodiment, the student terminal 30 that transmits an answer similar to the correct answer data is determined among the student terminals 30 of the students who raise their hands. Thus, the teacher terminal 10 can reduce the risk of sharing an incorrect answer.

### Fifth Embodiment

The information sharing system 100 for allowing the teacher to set how the identification unit 51 determines the student terminal 30 is described below.

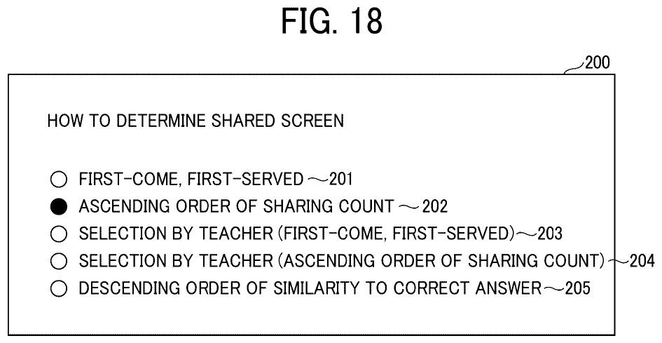

FIG. 18 illustrates a determination-method setting screen 200 displayed on the teacher terminal 10. The determination-method setting screen 200 displays multiple-choice options in association with radio buttons. The multiple-choice options are: first-come, first-served 201; ascending order of sharing count 202; selection by teacher (first-come, first-served) 203; selection by teacher (ascending order of sharing count) 204; and descending order of similarity to correct answer 205. The ascending order of sharing count 202 corresponds to the first embodiment, the selection by teacher (first-come, first-served) 203 corresponds to the second embodiment, the selection by teacher (ascending order of sharing count) 204 corresponds to the third embodiment, and the descending order of similarity to correct answer 205 corresponds to the fourth embodiment.

According to the present embodiment, the teacher can set the method for determining the student terminal 30 from which the screen data is to be displayed on the teacher terminal 10.

### Sixth Embodiment

The information sharing system 100 in which the teacher terminal 10 determines the student terminal 30 to share the screen data is described below.

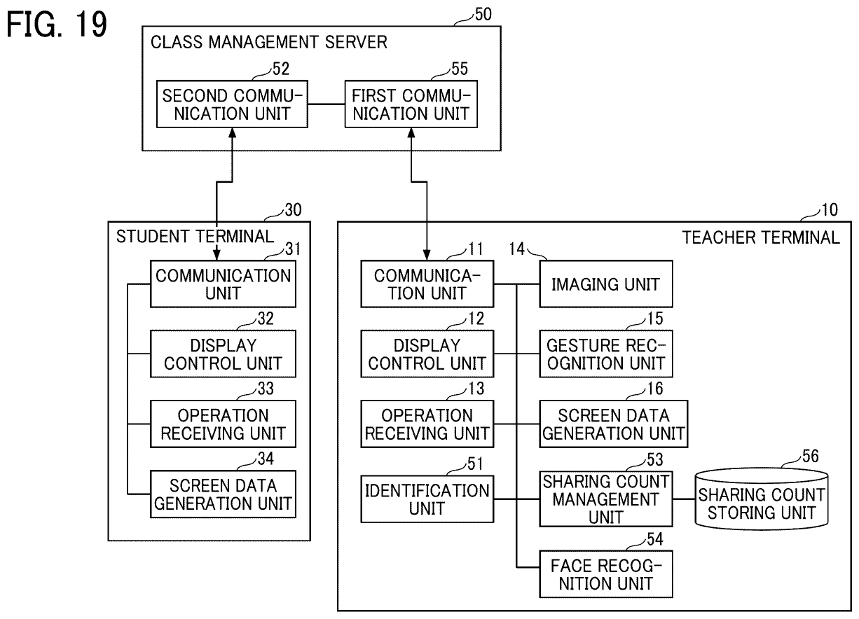

FIG. 19 is a block diagram illustrating a functional configuration of the class management server 50, the student terminal 30, and the teacher terminal 10. The differences from FIG. 4 are described below with reference to FIG. 19. The teacher terminal 10 includes the communication unit 11, the display control unit 12, the operation receiving unit 13, the imaging unit 14, the gesture recognition unit 15, the screen data generation unit 16, the identification unit 51, the sharing count management unit 53, the face recognition unit 54, and the sharing count storing unit 56. In other words, the teacher terminal 10 has the functions of the class management server 50.

The class management server 50 includes the first communication unit 55 and the second communication unit 52. The class management server 50 controls the student terminals 30 and the teacher terminal 10 that participate in the same class. The class management server 50 performs control related to communication such as session control between the student terminals 30 and the teacher terminal 10. The teacher terminal 10 recognizes the students and determines the student terminal 30 to share the screen data.

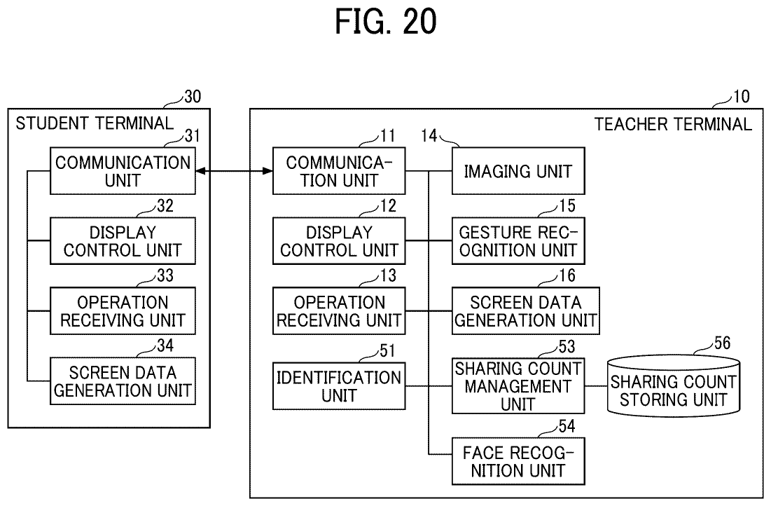

Alternatively, the class management server 50 may be omitted as illustrated in FIG. 20. FIG. 20 is a block diagram illustrating a functional configuration of the student terminal 30 and the teacher terminal 10. As illustrated in FIG. 20, the student terminal 30 and the teacher terminal 10 directly communicate with each other, rendering the class management server 50 unnecessary and reducing the installation cost.

### Other Application Examples

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, the teacher terminal 10 may transmit a model answer to a student who raises their hand. Thus, the student can score whether their answer is correct. Alternatively, the teacher terminal 10 may determine whether the answer is correct or incorrect. When the answer is correct, the teacher terminal 10 may transmit a model answer to the student terminal 30. When the answer is incorrect, the teacher terminal 10 may transmit a message indicating that the answer is incorrect along with a hint to the student terminal 30. When the number of incorrect answers exceeds a certain number, the teacher terminal 10 may transmit a model answer to the student terminals 30.

The teacher terminal 10 may be referred to as an electronic whiteboard or an electronic information board instead of an electronic blackboard. The present disclosure can be suitably applied not only to electronic blackboards but also to any information processing device with a touch panel. Examples of an information processing device equipped with a touch panel include a PC, a tablet terminal, and a smartphone each having a touch panel. These are general-purpose information processing devices. However, when an application that functions as the teacher terminal 10 is executed, the user can operate the information processing device as the teacher terminal 10.

The teacher terminal 10 may project images by a projector. In this case, the teacher terminal 10 detects the coordinates of the pointing position by one or more methods described above, and the projector projects, for example, a writing line based on the trajectory of the coordinates.

Although the gesture of raising a hand is detected, motions such as nodding, raising a thumb, or shaking a head may be detected in the same sense as raising a hand.

In the configurations illustrated in the accompanying drawings such as FIG. 6, the processing by the class management server 50, the teacher terminal 10, and the student terminal 30 are divided according to the main functions to facilitate understanding. The present disclosure is not limited by how the processing is divided or by the names of the processing units. The processing by the class management server 50, the teacher terminal 10, and the student terminal 30 can be divided into more processing units according to the processing content. Also, a single processing unit can be divided to include more processing units.

According to one or more aspects of the present disclosure, the bias in selecting a user who performs a gesture is reduced.

The functionality of the elements disclosed herein may be implemented using circuitry or processing circuitry which includes general-purpose processors, special-purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc read-only memory (CD-ROM) or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

1. An information sharing system, comprising:
a device including device circuitry;
at least one terminal device; and
a server device communicatively connected to the device and the at least one terminal device, the server device including server circuitry,
the device circuitry and the server circuitry being configured to operate in cooperation to:
acquire image data from an imaging device that captures an image of a user of the at least one terminal device;
analyze the acquired image data to recognize a gesture;
store, in a memory, sharing count in association with the user of the at least one terminal device, the sharing count being number of times the device displays information displayed on the at least one terminal device;
perform face recognition on the image data to identify the user who performs the gesture;
identify the user with lowest sharing count among users of the at least one terminal device who perform the gesture;
receive the information from the at least one terminal device associated with the identified user; and
display the received information on a display of the device.

2. The information sharing system according to claim 1,
wherein the device circuitry and the server circuitry are configured to operate in cooperation to determine an order of the user based on an order in which the circuitry recognizes the user who performs the gesture, and
wherein the device circuitry displays identification information of the user in association with the sharing count of the user in the determined order.

3. The information sharing system according to claim 2,
wherein the device circuitry and the server circuitry are configured to operate in cooperation to receive the information from the at least one terminal device associated with a selected user among the identification information of the users displayed in the determined order, and
wherein the device circuitry displays the received information.

4. The information sharing system according to claim 1,
wherein the device circuitry and the server circuitry are configured to operate in cooperation to sort the user who performs the gesture in ascending order of sharing count, and
wherein the device circuitry displays identification information of the user who performs the gesture in the sorted order.

5. The information sharing system according to claim 4,
wherein the device circuitry and the server circuitry are configured to operate in cooperation to receive the information from the at least one terminal device associated with the user with the lowest sharing count, and
wherein the device circuitry displays the received information.

6. The information sharing system according to claim 4,
wherein the device circuitry and the server circuitry are configured to operate in cooperation to receive the information from the at least one terminal device associated with a selected user among the identification information of the users displayed in the sorted order, and
wherein the device circuitry displays the received information.

7. The information sharing system according to claim 1,
wherein the device circuitry and the server circuitry are configured to operate in cooperation to:
store correct answer data of a question answered by the user of the at least one terminal device;
calculate a similarity between the correct answer data and the information acquired from the at least one terminal device associated with the user who performs the gesture; and
receive the information from the at least one terminal device that transmits an answer determined to be most similar to the correct answer data, and wherein the device circuitry displays the received information.

8. The information sharing system according to claim 7,
wherein the device circuitry and the server circuitry are configured to operate in cooperation to receive the information from the at least one terminal device associated with the user with the lowest sharing count among the users of the at least one terminal device that transmits the information with the calculated similarity equal to or greater than a threshold, and
wherein the device circuitry displays the received information.

9. The information sharing system according to claim 7,
wherein the device circuitry displays:
a screen to receive selection of one of options to determine the at least one terminal device to share the information,
the options including:
displaying the information acquired from the at least one terminal device associated with the user who performs the gesture earliest;
displaying the information acquired from the at least one terminal device associated with the user with the lowest sharing count among the users who perform the gesture;
displaying the information acquired from the at least one terminal device associated with a selected user among identification information of the users displayed in an order in which the users perform the gesture;
displaying the information acquired from the at least one terminal device associated with a selected user among the identification information of the users who perform the gesture and displayed in ascending order of sharing count; and
displaying the information acquired from the at least one terminal device having transmitted the answer determined to be most similar; and
the information received from the at least one terminal device determined based on the selection.

10. An information sharing method, comprising:
acquiring image data from an imaging device that captures an image of a user of at least one terminal device; analyzing the image data to recognize a gesture;
storing sharing count in association with the user of the at least one terminal device, the sharing count being number of times a device displays information displayed on the at least one terminal device;
performing face recognition on the image data to identify the user who performs the gesture;
identifying the user with lowest sharing count among users of the at least one terminal device who perform the gesture;
receiving the information from the at least one terminal device associated with the identified user; and
displaying the information received from the at least one terminal device.

11. A server device, comprising circuitry configured to:
communicate with a device and at least one terminal device through a network, the device acquiring image data from an imaging device and analyzing the image data to recognize a gesture, the imaging device capturing an image of a user of the at least one terminal device;
store, in a memory, sharing count in association with the user of the at least one terminal device, the sharing count being number of times the device displays information displayed on the at least one terminal device;
perform face recognition on the image data received from the device to identify the user who performs the gesture;
identify the user with lowest sharing count among users of the at least one terminal device who perform the gesture;
receive the information from the at least one terminal device associated with the identify user; and
transmit the information to the device.
